(19) United States
(12) Patent Application Publication
(10) Pub. No.: US 2010/0256248 A1
(43) Pub. Date: Oct. 7, 2010

(54) STRETCH BLOW MOLDING MONOVINYLIDENE AROMATIC POLYMERS

(76) Inventors: Rodolfo Salmang, Terneuzen (NL); Enrique Torres, Thalwil (CH); Julien Damen, Mettmenstetten (CH); Amaia Montoya-Goni, Bergen Op Zoom (NL)

Correspondence Address: The Dow Chemical Company, P.O. BOX 1967, Midland, MI, 48641, US

(21) Appl. No.: 12/739,281

(22) PCT Filed: Oct. 23, 2008
(86) PCT No.: PCT/US08/80877

§ 371 Date: Apr. 22, 2010

Related U.S. Application Data
(60) Provisional application No. 60/999,995, filed on Oct. 23, 2007.

(51) Int. Cl. C08L 51/04; B29C 49/08

(52) U.S. Cl. 521/139; 264/535

(57) ABSTRACT

According to the present invention there are provided improved rubber modified monovinylidene aromatic polymers having the specified relatively high molecular weight and the necessary rubber levels and particles. These improved resins are specially adapted and suited for use in stretch blow molding processes. They provide improved combinations of container neck strength and toughness, wall strength and stiffness and packaging efficiency. The present invention provides the makers of stretch blow molded containers with options for improved packaging cost and efficiency.

This application claims the benefit of U.S. Provisional Application No. 60/999,995 filed Oct. 23, 2007.

This invention relates to improved rubber-modified monovinylidene aromatic polymers which are especially suited for use in stretch blow molding processes. This invention, in another embodiment, also relates to such resins in the form of improved preforms for use in stretch blow molding processes and in the form of improved stretch blow molded articles. In this application these resins provide a combination of packaging efficiency, improved surface appearance and physical properties.

Stretch blow molding (SBM) machinery is designed to rapidly mold packaging and containers for beverages, dairy products, medications and other products from molded preforms and thin sheets. See for example; U.S. Pat. No. 3,775,524; U.S. Pat. No. 4,145,392; U.S. Pat. No. 4,668,729; EP 870,593; EP 1,265,736; EP 1,679,178A; JP 09-194,543; WO 96/08,356A; WO 2005/074,428A; WO 2005/077,642; WO 2006/040,627A; WO 2006/040,631A; and WO 2007/060,529A.

U.S. Pat. No. 7,208,547 teaches the use of certain rubber modified monovinylidene aromatic polymers for thermoforming and other forming processes providing a high degree of polymer orientation, including extrusion blow molding and injection stretch blow molding.

Commonly assigned co-pending International Application Serial Number PCT/US2008/061562, filed Apr. 25, 2008, discloses that certain blends of rubber modified monovinylidene aromatic polymers with a minor olefin polymer component are very suitable for use in a stretch blow molding processes where a controlled gloss surface is desired.

Published PCT Application WO 2007/124894 teaches stretch blow molding processes using polystyrene resins.

It is always desired by the makers and users of stretch blow molded plastic containers to obtain greater packaging efficiency in terms of minimizing the container cost and/or material required while maximizing the container contents. For example, one aspect of packaging efficiency can be measured as the ratio of the container content in milliliters (of water) to the weight of the unfilled container in grams. It is also desirable to obtain the molded containers in the shortest cycle time. Therefore, it would be generally desired to provide an improved resin which in turn provided stretch blow molded articles having improved combinations of container wall strength, neck/rim section toughness and processability under biaxial orientation conditions in a stretch blow molding process.

In one embodiment the present invention is a rubber modified monovinylidene aromatic polymer composition in the form of a stretch blow molded article, the composition comprising: (A) a monovinylidene aromatic polymer a having a weight average molecular weight (Mw) of from about 190,000 to about 350,000 g/mol; (B) from about 3.5 to about 10 percent by weight based on the weight of components (A), (B) and (C) of a grafted, cross-linked rubber polymer; (C) optionally up to about 5 percent by weight based on the weight of components (A), (B) and (C) of a plasticizer; and (D) optional non-polymeric additives and stabilizers. In other alternatives of this embodiment of the invention the plasticizer is selected from the group of: one or more mineral oil, one or more non-mineral oil, and blends of one or more mineral oil with one or more non-mineral oil; the Mw of the monovinylidene aromatic polymer is from at least about 215,000 to less than or equal to about 260,000 g/mol; the monovinylidene aromatic polymer is polystyrene has been mass, bulk or solution polymerized in the presence of at least one rubber polymer; and/or the rubber polymer is selected from the group consisting of 1,3-butadiene homopolymer rubbers, copolymers rubbers of 1,3-butadiene with one or more copolymerizable monomer and mixtures of two or more of these.

In a further alternative embodiment, the inventive composition in the form of a stretch blow molded article consists essentially of: (A) monovinylidene aromatic polymer a having a weight average molecular weight (Mw) of from about 220,000 to about 260,000 g/mol; (B) from about 4 to about 6 percent by weight based on the weight of components (A), (B) and (C) of a rubber polymer in the form of grafted, cross-linked particles having a volume average rubber particle size of from about 2 to about 5 microns; (C) from about 3 to about 4 percent by weight based on the weight of components (A), (B) and (C) of a plasticizer; and (D) optional non-polymeric additives and stabilizers. In alternative embodiments of this aspect of the present invention, the stretch blow molded article can be a thermoformed article or a container stretch blow molded from an injection molded preform, one embodiment being where the container is stretch blow molded from a compression molded preform.

In another embodiment the present invention is a rubber modified monovinylidene aromatic polymer composition comprising: (A) a monovinylidene aromatic copolymer a having a weight average molecular weight (Mw) of from about 215,000 to about 350,000 g/mol; (B) from about 3.5 to about 40 percent by weight based on the weight of components (A), (B) and (C) of a rubber polymer in the form of grafted, cross-linked particles having a volume average rubber particle size of from about 1.5 to about 10 microns; (C) optionally up to about 5 percent by weight based on the weight of components (A), (B) and (C) of a plasticizer; and (D) optional non-polymeric additives and stabilizers. Possible alternative variations of this embodiment include where the composition has an elongation at rupture value of from about 25 to about 70%; the monovinylidene aromatic polymer has a weight average molecular weight (Mw) of from about 220,000 to about 350,000 g/mol; the monovinylidene aromatic polymer composition comprises from about 1.5 to about 5 percent by weight of a plasticizer; the polymer composition comprises from about 3.5 to about 10 percent by weight rubber polymer; the Mw of the monovinylidene aromatic polymer is from about 240,000 to about 300,000 g/mol; the monovinylidene aromatic polymer is polystyrene that has been mass, bulk or solution polymerized in the presence of at least one rubber polymer; and/or the rubber polymer is selected from the group consisting of 1,3-butadiene homopolymer rubbers, copolymers rubbers of 1,3-butadiene with one or more copolymerizable monomer and mixtures of two or more of these.

In a preferred embodiment the composition according to the present invention comprises (A) polystyrene a having a weight average molecular weight (Mw) of from about 240,000 to about 260,000 g/mol; (B) from about 4 to about 6 percent by weight based on the weight of components (A), (B) and (C) of a rubber polymer in the form of grafted, cross-linked particles having a volume average rubber particle size of from about 2 to about 5 microns; (C) from about 3 to about 4 percent by weight based on the weight of components (A), (B) and (C) of a plasticizer; and (D) optional non-polymeric additives and stabilizers.

In a further alternative embodiment the present invention can be a process for preparing a stretch blow molded article comprising the steps of A. molding a preform from a monovinylidene aromatic polymer resin according to the previous embodiment; B. heating the preform; C. stretching the preform in a stretch blow molding apparatus; D. blowing the preform to the stretch blow molded article shape; and E. cooling and ejection of the stretch blow molded article from the stretch blow molding apparatus with the preform optionally being injection or compression molded.

As mentioned above, resins that can improve packaging efficiency need to provide improved combinations of container wall strength, neck/rim section toughness and processability under biaxial orientation conditions in a stretch blow molding process. This combination of features in stretch blow molded containers is generally attempted by reducing the container wall thickness while using a higher molecular weight resin and providing maximum biaxial polymer orientation to provide sufficient container wall strength. Regarding the container wall strength, it is well recognized by practitioners in this field that container wall strength and stiffness are needed to sufficiently support the top loading that occurs when the filled containers are packaged, stored and/or shipped.

Unfortunately, however, while the use of a high molecular weight resin material and/or biaxial orientation in the wall areas can provide sufficient wall strength and stiffness, it generally does not provide any added strength or sufficient toughness in the shoulder section where the container diameter is narrowing down, and especially in the neck or rim sections of the container where the container diameter is the narrowest due to the fact that there is little or no orientation from the molding process. Without sufficient toughness in the shoulder, neck or rim sections of the container, these areas are too brittle and will crack or break with the forces required for mechanical application of closures such as threaded screw tops or adhesively sealed lids. Although added impact modification components can improve the resin toughness in the less oriented container sections, these materials tend to be detrimental to the container wall stiffness and resin processability.

It has been found that the improved resins according to the present invention are capable of providing this property combination in stretch blow molded containers. As described further below, these resins combine the highest possible resin Mw together with an optimized rubber component that allows a high degree of orientation during the stretch blow molding process (providing wall strength and/or stiffness, light weight) and provides sufficient elongation, ductility and toughness to avoid brittleness in non- and low-oriented areas of the container.

In comparing the resins, processes and molded articles according to the present invention to those of the prior art, it was found that, especially in the area of stretch blow molded containers, they provided property combination improvements, particularly in the areas of weight reduction, improved desirable wall thickness distribution, increased dimensional stability, and providing sufficient toughness in non-oriented sections; all translated into a higher packaging efficiency ratio.

According to the present invention as compared to resins and containers of the prior art, within a given set of parameters, there were improvements in one or more desirable properties while at least maintaining one or more of the other properties. The present invention provides the makers of many types of containers with options for improved packaging efficiency meaning that less weight of resin is required to make a given size of container, providing obvious advantages in terms of raw material costs and reduced container shipping weight.

The monovinylidene aromatic polymers (including both homo- and copolymers) suitable for use in the present invention are well known and commercially available, As known to practitioners in this area, they are produced by polymerizing monovinylidene aromatic monomers. The monovinylidene aromatic monomers suitable for producing the polymers and copolymers used in the practice of this invention are preferably of the following formula:

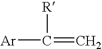

in which R′ is hydrogen or methyl, Ar is an aromatic ring structure having from 1 to 3 aromatic rings with or without alkyl, halo, or haloalkyl substitution, wherein any alkyl group contains 1 to 6 carbon atoms and haloalkyl refers to a halo substituted alkyl group. Preferably, Ar is phenyl or alkylphenyl (in which the alkyl group of the phenyl ring contains 1 to 10, preferably 1 to 8 and more preferably 1 to 4, carbon atoms), with phenyl being most preferred. Typical monovinylidene aromatic monomers which can be used include: styrene, alpha-methylstyrene, all isomers of vinyl toluene, especially para-vinyltoluene, all isomers of ethyl styrene, propyl styrene, vinyl biphenyl, vinyl naphthalene, and vinyl anthracene, and mixtures thereof with styrene being the most preferred.

The monovinylidene aromatic monomer can be copolymerized with minor amounts of one or more of a range of other copolymerizable monomers. Preferred comonomers include nitrile monomers such as acrylonitrile, methacrylonitrile and fumaronitrile; (meth)acrylate monomers such as methyl methacrylate or n-butyl acrylate; maleic anhydride and/or N-arylmaleimides such as N-phenylmaleimide, and conjugated and nonconjugated dienes. Representative copolymers include styrene-acrylonitrile (SAN) copolymers. If used, the polymerized comonomer will typically be present in the monovinylidene aromatic polymer in minor amounts, for example, in at least measurable amounts, generally at least about 0.1 weight percent (wt %) based on weight of the monovinylidene aromatic copolymer without the rubber, preferably at least about 1 weight percent, preferably at least about 2 and more preferably at least about 5, wt % of units derived from the comonomer based on weight of the copolymer. If comonomers are included in minor amounts, the polymerized comonomer level in the monovinylidene aromatic polymer is typically less than about 40 weight percent, preferably less than about 20, more preferably less than about 15, more preferably less than about 10, more preferably less than about 5 and most preferably less than about 3 wt % based on the weight of the copolymer.

Selection of the appropriate, relatively high weight average molecular weight (Mw) of the monovinylidene aromatic polymers (homopolymer or copolymer) is important in the practice of this invention. For reasons of providing mechanical strength and melt strength that will retain the biaxial orientation in the form of a stretch blow molded article, the resin Mw needs to be at least about 190,000, preferably at least about 200,000, more preferably at least about 205,000, more preferably at least about 210,000, and more preferably at least about 215,000, more preferably at least about 220,000, and most preferably at least about 230,000 g/mol. Although the highest possible molecular weights would enhance the performance of the resin, for reasons of processability and equipment limitations of the production processes, the Mw is generally less than or equal to about 350,000, preferably less than or equal to about 330,000, preferably less than or equal to about 300,000, more preferably less than or equal to about 260,000 and, more preferably less than or equal to about 250,000 g/mol. With the use of copolymers of monovinylidene aromatic monomers, the Mw and molecular weight distribution fall generally into the same ranges but may have some specific preferences as known for use in the copolymers. As used herein, Mw, Mn and molecular weight distribution are typically determined by gel permeation chromatography using a polystyrene standard for calibration.

Along with the Mw values, the Mn (number average molecular weight) and ratio of Mw/Mn, also known as polydispersity or molecular weight distribution, are an important aspect. Typically, the Mw/Mn ratio is at least about 2.3, preferably at least about 2.4 and more preferably at least about 2.5. The molecular weight distribution ratio typically is less than or equal to about 3.0, preferably less than or equal to about 2.8, more preferably less than or equal to about 2.7, and most preferably less than or equal to about 2.6. As mentioned above, the Mw and Mn are typically determined by gel permeation chromatography using a polystyrene standard for calibration.

With knowledge of the desired compositions and targets for Mw, Mn and molecular weight distribution in the resins which are provided according to the present invention, skilled practitioners can utilize the known polymerization or blending technologies to provide these resins from monomers or from amounts of two or more component resins.

In order for the resin to have the combination of resin Mw, Mn, rubber content, and plasticizer to provide the necessary elongation, ductility and improved toughness to avoid brittleness in the non-oriented container neck areas, the monovinylidene aromatic polymers and copolymers used in the practice of this invention need to contain or be blended or graft polymerized with one or more rubbers to form a high impact monovinylidene aromatic polymer or copolymer. For example, to obtain the rubber component (a) GPPS or SAN can be blended with a rubber or (b) the corresponding monomers, styrene or styrene and acrylonitrile, graft polymerized with rubber to produce rubber modified resins such as HIPS or ABS. The rubber is typically an unsaturated rubbery polymer having a glass transition temperature (Tg) of not higher than about 0° C., preferably not higher than about −20° C., as determined by ASTM D-756-52T. Tg is the temperature or temperature range at which a polymeric material shows an abrupt change in its physical properties, including, for example, mechanical strength. Tg can be determined by differential scanning calorimetry (DSC).

The rubbers suitable for use in the present invention are those that have a solution viscosity in the range of about 5 to about 300 centipoise (cps, 5 percent by weight styrene at 20 C) and Mooney viscosity of about 5 to about 100 (ML+1, 100 C). Suitable rubbers include, but are not limited to, diene rubbers, diene block rubbers, butyl rubbers, ethylene propylene rubbers, ethylene-propylene-diene monomer (EPDM) rubbers, ethylene copolymer rubbers, acrylate rubbers, polyisoprene rubbers, halogen-containing rubbers, silicone rubbers and mixtures of two or more of these rubbers. Also suitable are interpolymers of rubber-forming monomers with other copolymerizable monomers. Suitable diene rubbers include, but are not limited to polymers of conjugated 1,3-dienes, for example, butadiene, isoprene, piperylene, chloroprene, or mixtures of two or more of these dienes. Suitable rubbers also include homopolymers of conjugated 1,3-dienes and interpolymers or copolymers of conjugated 1,3-dienes with one or more copolymerizable monoethylenically unsaturated monomers, for example, such homopolymers or copolymers of butadiene or isoprene, with 1,3-butadiene homo- or copolymers being especially preferred. Such rubbers also include mixtures of any of these 1,3-diene rubbers. Other rubbers include homopolymers of 1,3-butadiene and include copolymers of 1,3-butadiene with one or more copolymerizable monomers, such as monovinylidene aromatic monomers as described above, styrene being preferred. Preferred copolymers of 1,3-butadiene are random, block or tapered block rubbers of at least about 30, more preferably at least about 50, even more preferably at least about 70, and still more preferably at least about 90, wt % 1,3-butadiene, and preferably up to about 70, more preferably up to about 50, even more preferably up to about 30, and still more preferably up to about 10, wt % monovinylidene aromatic monomer, all weights based on the weight of the 1,3-butadiene copolymer.

As known to those skilled in the art, the 1,3-diene rubbers can further have molecular weight distributions that are optimized for providing desired rubber particle morphologies. Among other things, known coupling agents can be utilized to provide higher molecular weight rubbers or a high molecular weight component for a bimodal molecular distribution.

In general, the rubber in the rubber-modified polymers of this invention is typically present in an amount of greater than at least 3.5 weight percent (wt %) based on total rubber-modified monovinylidene aromatic polymer in order to provide sufficient toughness in the neck and rim areas, preferably at least about 3.7 wt %, and more preferably at least about 4 wt % based on the weight of the rubber-modified polymer.

Except in the case of monovinylidene aromatic copolymers, the rubber in the rubber-modified polymers of this invention the rubber in the rubber-modified polymers of this invention is typically present in an amount less than or equal to about 10 weight percent (wt %) based on the weight of the rubber-modified polymer in order to provide sufficient wall strength and stiffness, preferably less than or equal to about 9, more preferably less than or equal to about 8, and most preferably less than or equal to about 7 wt % based on the weight of the rubber-modified polymer. The rubber content of the final rubber modified monovinylidene aromatic polymer composition as used herein is measured for copolymer rubber components by counting only diene content from the copolymer rubber component and not including any copolymerized monovinylidene or other non-diene monomer that is part of the copolymer rubber.

In the case of monovinylidene aromatic copolymers, the rubber can be added at higher levels and is typically present in an amount less than or equal to about 40 weight percent (wt %) based on the weight of the rubber-modified polymer, preferably less than or equal to about 30 wt %, more preferably less than or equal to about 25 wt %, and more preferably less than or equal to about 20 wt % based on the weight of the rubber-modified polymer.

The rubber modified monovinylidene aromatic resins according to the present invention can utilize a broad range of morphologies, average particle sizes and particle size distributions for the group of rubber particles, all of which are known to those skilled in the art. The rubber particles dispersed within the rubber modified monovinylidene aromatic polymer matrix can have one or more of the known rubber particle morphologies including single occlusion morphology referred to as core/shell or capsule particle morphology or more complex rubber particle morphologies that are known in the art and have structures that can be described as cellular, entangled, multiple occlusions, labyrinth, coil, onion skin or concentric circle.

The rubber particles in the compositions according to the present invention, in order to provide sufficient resin elongation and toughness, will typically have a volume average diameter of at least about 1.5 microns (“μ”, micrometer or μm), preferably at least about 1.6 microns, more preferably at least about 1.7 microns, more preferably greater than 1.8 microns, more preferably at least about 1.9 microns, and most preferably at least about 2 microns and typically less than or equal to about 10 microns, preferably less than or equal to about 7 microns and more preferably less than or equal to about 5 microns, more preferably less than or equal to about 4 and most preferably less than or equal to about 3.5 microns. As used herein, the volume average rubber particle size or diameter refers to the diameter of the rubber particles, including all occlusions of monovinylidene aromatic polymer within the rubber particles. Particle sizes in these ranges can typically best be measured using electrophoresis measurement techniques, such as equipment provided by Beckman Coulter, Inc. including the Multisizer™ brands of particle counters. If needed for larger average rubber particle sizes and for morphology analysis, transmission electron microscopy image analysis is can be used. Those skilled in the art recognize that different sized groups of rubber particles may require some selection or modification of rubber particle measurement techniques for optimized accuracy.

In connection with the rubber content of the resins according to the invention, it has also been found that the measured elongation value for these resins is important in their performance in stretch blow molding applications. As known to practitioners in this area, the elongation at rupture (“elongation” or “E” value) is measured on tensile bars in a tensile testing device (for example an Instron universal testing machine) at a strain rate of 5 mm/min according standard tensile test method ISO 527. It is important for test result consistency to prepare the test samples carefully by injection molding under ISO 2897-2 standard conditions (melt temperature of 210° C., injection speed 35 mm/min) at a shear rate of 414 reciprocal seconds (s⁻¹) and a total shear strain of 828 to produce 4 millimeter (mm) thick tensile test bars. The samples should be carefully inspected prior to testing to avoid any bubbles, dust contamination and/or any other flaws or defects.

It has been found that for good performance in stretch blow molding articles, the resins according to the present invention should exhibit elongation values of at least about 25 percent (%), preferably at least about 30% and more preferably at least about 35%. On the other hand, to maintain the wall stiffness in stretch blow molded articles, it has been found that the resins should exhibit elongation values less than or equal to about 75%, preferably less than or equal to about 65% and more preferably less than or equal to about 55%.

Preferred monovinylidene aromatic polymers include HIPS resins containing about 4 to 7 weight percent of a polybutadiene rubber in the form of particles having an average particle diameter in the range of from about 1.5 to about 4 microns.

The use of plasticizers has been found to be necessary to provide the suitable level of processability, avoid any flow or cut marks in the molded preforms and maintain low cycle times. The plasticizer can be added, if needed, or may already be contained to some degree in one of the monovinylidene aromatic polymer components. Representative plasticizers for the monovinylidene aromatic polymer component include mineral oils, nonfunctionalized nonmineral oils, single component hydrocarbons such as cyclohexane, unsaturated or saturated ethylene propylene copolymers, or low molecular weight polyolefin waxes. The various types of mineral oil plasticizers for use in these types of compositions are commercially available and known to practitioners in this field. Preferred mineral oil plasticizers would include low volatility white mineral oils and “plastic oils” which are available under trade names such as Drakeol™ from Penreco and Hydrobrite™ from Sonneborn. These mineral oils will generally have a kinematic viscosity as measured by ASTM D-445 at 40° C. of at least 10 centiStokes (cSt), preferably at least 25, and more preferably at least 50 cSt and less than 250 cSt, preferably less than 150, and more preferably less than 130 cSt.

As mentioned above, the representative plasticizers can also include nonfunctionalized, nonmineral oils including such vegetable oils as those derived from peanuts, cottonseed, olives, rapeseed, high-oleic sunflower, palm, and corn. These oils also typically include animal oils that are liquid under ambient conditions, such as some fish oils, sperm oil and fish-liver oils, and can include lard, beef tallow and butter. These nonfunctionalized, nonmineral oils can be used alone or in combination with one or more other mineral or nonmineral oils.

The amount of plasticizer used in the compositions of this invention can vary somewhat, particularly depending upon the effectiveness of the type that is selected, but typically the amount used in the composition is at least about 1.5 weight percent (wt %) based on the total weight of the polymer, preferably at least about 2, more preferably at least about 2.4, more preferably at least about 2.6, and especially for use in SBM applications where the preform is compression molded, most preferably at least about 3.0 wt % plasticizer based on the total weight of the polymer. The only limits on the maximum amount of plasticizer blend that can be used in the compositions of this invention are those set by cost and practical considerations, but typically the maximum amount of the blend in these compositions is less than or equal to about 5, preferably less than or equal to about 4 and more preferably less than or equal to about 3.5, wt % based on the total weight of the polymer. The plasticizer can be added before and/or after the formation of the monovinylidene polymers. It is also noted that these nonfunctionalized, nonmineral oils are somewhat more effective than equivalent weight amounts of mineral oil and can be used in slightly lesser amounts.

In addition to the monovinylidene aromatic polymer(s) and plasticizer, the resin compositions of this invention can contain further additive components including the known colorants including dyes and pigments, fillers, mold release agents, stabilizers and IR absorbers. These other components are known in the art, and they are used in the same manner and amounts as they are used in known monovinylidene aromatic polymers.

The resins according to the present invention can be made by any of the various methods known in the art, including directly polymerizing the rubber modified monovinylidene aromatic polymer in any of the generally known mass, bulk, or solution graft polymerization processes, or blending rubber or a rubber-containing monovinylidene aromatic polymer with a separately prepared, neat monovinylidene aromatic polymer component. In cases of using a combination of monovinylidene aromatic polymers, the methods are also known for blending or compounding additives or blend components into monovinylidene aromatic polymers, such as in various types of specialized blending or compounding equipment or in other unit operations with a melt mixing step, such as in the extruder screw of a molding machine. The combination of the two can be done either with prior dry blending or by metering separate feeds of one or both into the melt mixing apparatus.

The resins according to the present invention can be prepared using as one of the components providing the rubber particle component, commercially available HIPS products from The Dow Chemical Company under the trade name of STYRON™ A-TECH™ 1200. Using a blend of a HIPS resin and a GPPS has been found to be useful in order to facilitate obtaining the desired combinations of high monovinylidene aromatic polymer molecular weight and optimized rubber level and rubber particle size. In a preferred embodiment, the desired monovinylidene aromatic polymer composition is provided by blending HIPS and GPPS resins in a molding machine.

The resins of this invention can be used in the manufacture of various articles, including but not limited to, containers, packaging, components for consumer electronics and appliances. These resins are used in the same manner as known monovinylidene aromatic polymers, for example, extrusion, injection and compression molding, thermoforming, etc. The resin compositions according to the invention are, however, especially suited for stretch blow molding (“SBM”) applications and, in one embodiment, the present invention is an improved stretch blow molding process. Examples of suitable known stretch blow molding processes (using injection molded preforms) are shown in WO 96/08356A; EP 870,593; JP 07-237,261A; and WO 2005/074428A. The use of compression molded preforms in suitable stretch blow molding processes are shown in WO 2005/077642A; WO 2006/040,631A; and WO 2006/040,627A.

The monovinylidene aromatic polymer resins according to the present invention are used in these processes generally according to their standard operation conditions as adjusted accordingly for use of the appropriate monovinylidene aromatic polymer processing temperatures and conditions. In these processes the preform is prepared by compression or injection molding, and used in either a one or two step stretch blow molding process.

The improved SBM process according to the present invention uses the resins as described above in the form of injection or compression molded preforms to provide improved stretch blow molded articles. Preferred preform injection molding conditions for using the resin compositions according to the present invention in a stretch blow molding process are injection pressures of from about 1,000 to about 28,000 pounds per square inch gauge (psig); preferably at about 22,000 psig and at temperatures in the range of from about 170 to about 280° C.; preferably at about 240° C. The use of the relatively high molecular weight resins according to the present invention may require appropriate injection molding conditions, such as, higher temperature heating in hot runner molds and/or a re-sized gate.

Preferred preform compression molding conditions for using the resin compositions according to the present invention in a stretch blow molding process are compression force of from about 1,000 to about 10,000 Newtons (N), preferably at about 5000 N and at temperatures in the range of from about 130 to about 190° C.; preferably at about 170° C.

The SBM process can then be performed in the known SBM equipment and generally according to the known process conditions as adjusted somewhat for the monovinylidene aromatic polymer resins according to the present invention.

In a two-step or reheat stretch blow molding process the preforms are produced in a discrete and separate first step, removed from the molding process, then cooled, optionally stored and then delivered to the subsequent stretch blow molding process. Then, for the stretch blow molding, the preform is reheated, stretched and blow molded in a separate stretch blow molding machine. Various heating methods can be used in the preform (re)heating section, including infrared, convection, and/or microwave heating.

The preform (either injection or compression molded) and SBM steps can take place in different locations with a two-step process and frequently the preform molder sells or delivers the preforms to a location where the container contents (such as dairy products) are produced, where the preforms are blow molded into bottles or containers and filled.

Alternatively, to make these processes more energy efficient, the stretch blow molding step on preforms can be done immediately or shortly after the preform molding step, maintaining the preform at the elevated temperature from the preform molding process, thus saving at least some of the heating that would otherwise be required. In such a single station stretch blow molding process, the molding of the preforms and the stretch and blow molding steps are both done on one machine unit, typically of a carousel type. The preforms are molded at one point by either injection or compression molding and then (while still retaining the heat from the molding process) stretched and blow molded in the container mold.

For either compression or injection molded types of preforms and with either a one or two stage process, the stretch blow molding process is similar and involves the same common series of steps:
Heating the perform—The body of the preforms are heated (optionally kept hot as possible from the molding step) to an appropriate heat-softened temperature that will yield sufficiently in the stretching and molding steps while the neck (or mouth or rim) is below that temperature to provide support to the preform during the stretching and blowing steps. The heating can be done by any known heating technique such as infrared, convection and/or microwave heating. The heating may have been done partially or completely in the preform molding process for a one-stage process. Alternatively, for a two-stage process, the heating is done by conveying the preform through heaters of conventional type(s).
Stretching the body of the preform—where the heat softened preform is physically stretched in a stretch blow molding apparatus with a stretching means such as a plunger or plug, to approximate the length dimension of the final container. The stretching is typically done at a strain rate of from about 10 to about 450 millimeters per second (mm/s); preferably at about 200 mm/s and at temperatures in the range of from about 130 to about 190° C.; preferably at about 160° C. In the stretching step the matrix and rubber particles are subjected to axial elongational strain which contribute to the mechanical properties of the SBM products.
blowing the preform to the stretch blow molded article shape—where fluid pressure, such as gas pressure, including air pressure, from inside the container and optionally vacuum from outside, shapes the preform to conform to the mold shape. The blowing step typically uses an internal pressure, such as air pressure, of from about 3 to about 20 bar; preferably at about 8 to 12 bar. During the blowing step the matrix and rubber particles are subjected to strains in the hoop direction or perpendicular to the axial strain which also contributes to the mechanical properties of the SBM products. The mold temperature is from about 15 to about 45° C., preferably at about 30° C., during the blowing pressure and holding stages for cooling times that are typically in the range of from about 1.5 to about 14 seconds, preferably less than 5 seconds and more preferably about 2 seconds.
cooling and ejection of the stretch blow molded article from the stretch blow molding apparatus—where the shaped container cools, solidifies sufficiently for physical contact and handling, the movement of the polymer chains is frozen and the molded container is removed from the SBM apparatus.

The resin compositions according to the invention are also suited for use in extruded sheet thermoforming processes which can also be viewed as a type of stretch blow molding process where the extruded sheet is the preform. Thermoforming processes are known in the art and can be done in several ways, as taught for example in “Technology of Thermoforming”; Throne, James; Hanser Publishers; 1996; pp. 16-29. In a “positive” thermoforming process a gas or air pressure is applied to the softened sheet, the sheet is then stretched like a bubble and a male mold is brought into the “bubble”. Then vacuum is applied to conform the part to the male mold surface. In this thermoforming process the required biaxial stretching/orientation is done primarily in one step when there is a gas or air pressure applied to the softened sheet. The sheet is thereby biaxially oriented when it is stretched like a bubble to nearly the final part size. The molding step is then completed with the vacuum and male mold to freeze the orientation into the sheet for a good balance of physical and appearance properties.

In a “negative” thermoforming process a vacuum or a physical plug is applied to the heat softened sheet and brings the sheet to nearly the final part size. Then, with positive air pressure or further external vacuum forming the sheet against an outer, female mold, the orientation is frozen into the polymer and the sheet is formed into the article. This negative thermoforming provides somewhat more axial orientation with somewhat less orientation in the hoop direction.

As discussed above, retention of sufficient by biaxial orientation is important in maintaining the wall strengths in stretch blow molded containers.

The following group of experiments is provided to illustrate various embodiments of the invention. They are not intended to limit the invention as otherwise described and claimed. All numerical values are approximate, and all parts and percentage are by weight unless otherwise indicated.

The following monovinylidene aromatic polymers were used:

TABLE 1
Monovinylidene Aromatic Polymers

| Grade | GPPS 1 | GPPS 2 | HIPS 1 | HIPS 2 |
|---|---|---|---|---|
| MFR | 2.4 | 2.5 | 4.8 | 2.8 |
| Mw | 265 | 325 | 160 | 190 |
| Mn | 115 | 140 | 60 | 84 |
| PB (%) | 0 | 0 | 8.5 | 7.7 |
| MO (%) | 0 | 3.4 | 2.5 | 3.0 |
| (70-85 cSt) | | | | |
| RPS | N/A | N/A | 2.5 | 6.0 |

As shown in Table 2 below, resins were evaluated for their suitability. The blend resins 1 and 2 were made by combining the indicated HIPS resin and a GPPS resins as identified in Table 1 above. The blend resin compositions in Table 2 below were prepared by dry blending in a 20° tilted tumbler for 20 minutes at 50 rpm. The blends were then compounded in a twin co-rotating screw extruder at 60 rpm and a melt temperature of 190° C.

The resin composition properties shown below were measured according the following test methods. Test samples for testing the resin physical properties were prepared by injection molding to prepare samples under ISO 2897-2 standard conditions (melt temperature of 210° C., injection speed 35 mm/min) at a shear rate of 414 reciprocal seconds (s⁻¹) and a total shear strain of 828 to produce 4 millimeter (mm) thick tensile test bars.

RPS—Rubber Particle Size in microns as measured using a Multisizer 3 instrument from Coulter Beckman, Inc. with a 30 micron tube.

Flexural Modulus in megapascals (Mpa)—measured using three point bending technique according to ISO 178 (equivalent to ASTM D790).

Notched Izod 23° C.—measured at 23° C. in kiloJoules per square meter (kJ/m²) according to ISO 180/1A.

Tensile strength at yield (“TsY”) at a strain rate of 5 mm/min—measured in MPa according to ISO 527.

Tensile strength at rupture (“TsR”) at a strain rate of 5 mm/min—measured in MPa according to ISO 527.

Elongation at Rupture—(“E”) measured at a strain rate of 5 mm/min according to ISO 527 on injection molded samples carefully inspected to avoid bubbles and dust contamination.

Vicat A—in ° C. measured according to ISO 306A using a 10 Newton weight mass.

TABLE 2
Resin Compositions and Properties

| Resin Composition | 1 | 2 | 3* | 4* |
|---|---|---|---|---|
| HIPS 1 (%) | 60 | 55 | 100 | |
| HIPS 2 (%) | | | | 100 |
| GPPS 1(%) | 40 | | | |
| GPPS 2 (%) | | 45 | | |
| MFR | 3.64 | 3.58 | 4.80 | 2.8 |
| Mw | 196 | 220 | 160 | 190 |
| Mn | 78 | 88 | 60 | 84 |
| Mw/Mn | 2.52 | 2.51 | 2.67 | 2.26 |
| PB (%) | 5.10 | 4.68 | 8.50 | 7.7 |
| MO (%) | 1.50 | 2.91 | 2.5 | 3.0 |
| RPS | 2.5 | 2.5 | | 6.0 |
| Flexural Modulus MPa | 2091 | 2950 | 1775 | 1650 |
| Izod N 23° C. kJ/m² | | 6.7 | 12 | 10.8 |
| TsY 5 mm/min MPa | 25.81 | 40 | 18.72 | 16 |
| TsR 5 mm/min MPa | | 40 | 21.06 | 24 |
| E at R 5 mm/min % | 58 | 30 | 67.6 | 60 |
| Vicat A ° C. | 104 | | 100 | |

*Comparative example, not an example of the present invention

The Resins 1 through 3 described above were stretch blow molded into larger (250 mL) bottles having a 58 mm exterior diameter at the main wall section, a 36.4 mm exterior diameter at the neck section and a tapering shoulder section between and Resins 3 and 4 into smaller (100 mL) bottles having a 60 mm exterior diameter at the widest wall section, a 41 mm exterior diameter at the neck section and a tapering shoulder section between using compression molded preforms in a stretch blow molding process. For compression molding the preform, the melt temperature of the resin “gob” or “pellet” was 195° C. and it was then compression molded on a match mold at temperatures of 110° C. for the female and 70° C. for the male tool for a compression time of 0.5 seconds. In the blowing step, the stretching rate was about 500 mm/second, followed by air pressure of 8 bar. The bottles were then tested and characterized using a series of tests commonly used in this industry, as described below, and the results of the bottle testing are shown below in Table 3.

Packaging Efficiency (ml/g)—container contents volume per gram container weight measured using water.

Top Load (N)—Force needed to cause an axial deformation of 3 mm in the container being compressed between two parallel plates closing at a speed of 10 mm/minute.

Specific Top Load in Newtons per gram (N/g)—The Top Load (measured as described above) divided by the container weight, giving strengths value per unit container weight.

Critical Wall Thickness—measured in millimeters, the thickness of bottle wall measured at the wall location where failure initiates under top loading test. This can vary among various bottle geometries. During prototype molding there were variations in the critical wall thickness, particularly the unintentional reduction shown in Experimental Composition 3, that generally reduced the Top Load result. With better control of molding process and uniformity of the critical wall thickness, optimized Top Load results can be obtained that reflect performance according the normalized values that were also calculated and shown.

Normalized Top Load—calculated from Top Load and Critical Wall Thickness and reported in Newtons per millimeter (N/mm). This shows Top Load value per unit of Critical Wall Thickness and represents the optimized use of the resin in the stretch blow molding process.

Biaxial Orientation A/H—testing of the orientation levels in the axial and hoop directions (biaxial orientation) at shoulder, middle and bottom sections of the bottle. This testing is done by cutting circles or discs of 22 mm diameter out of shoulder, middle and bottom locations of the container and previously marking the discs with the axial and hoop directions. The discs are heated in a convection oven for at 145° C. for five minutes and allowed to shrink freely as the frozen-in orientation relaxes. This results in shrinking the oriented disc sections into ellipses based on the amounts of directional orientation that are being relaxed. The percentage orientation is then calculated as follows:

$$\frac{( original dimension - final dimension )}{original dimension} \times 100$$

As discussed above, retention of sufficient by biaxial orientation is important in maintaining the wall strengths in stretch blow molded containers.

Neck strength test—the compressive strength of the bottle neck is measured using an Instron brand universal tensile tester and compressing the bottle neck opening between parallel plates from two sides at a rate of 10 mm per minute. The bottle neck is compressed until there is a 5% reduction in diameter with the bottle failing the test if there is any cracking or breaking failure observed at the neck. If there is no cracking or breaking and the bottle neck passes after a 5% diameter reduction, the test continues and the bottle neck is further compressed until there is a 10% reduction in diameter. This test is then passed if there is no observed cracking or breaking.

TABLE 3
Stretch Blow Molded Bottles

| | Composition number | | | | |
|---|---|---|---|---|---|
| | 1 | 2 | 3 | 3 | 4 |
| | Large | Large | Large* | Small* | Small* |
| Bottle Weight (g) | 10.5 | 10.5 | 10.8 | 5.75 | 6.24 |
| Bottle Capacity (ml) | 250 | 250 | 250 | 150 | 150 |
| Packaging Efficiency | 23.81 | 23.81 | 23.15 | 26.09 | 23.04 |
| (ml/g) | | | | | |
| Specific Top Load | 17.14 | 23.49 | 19.63 | 13.47 | 10.21 |
| (N/g) | | | | | |
| Top Load (N) | 180 | 246.6 | 212 | 78.4 | 63.7 |
| Critical Wall | 0.391 | 0.489 | 0.501 | | |
| Thickness (mm) | | | | | |
| Normalized Top | 455.8 | 504.7 | 422.7 | | |
| Load (N/mm) | | | | | |
| Orientation | | 60/40 | 35/30 | | |
| A/H - shoulder | | | | | |
| Orientation | | 50/35 | 30/30 | 65/28 | 49/49 |
| A/H - middle | | | | | |
| Orientation | | 60/40 | 35/30 | | |
| A/H -bottom | | | | | |
| Neck strength test | | | | | |
| 5% | Pass | Pass | Pass | N/A | N/A |
| 10% | Pass | Pass | Pass | | |

*Comparative example; not an example of the present invention.

As can be seen in Table 4 above, Compositions 1 and 2 had resin properties that were sufficient to provide good combinations of neck strength and toughness, bottle wall strength, and packaging efficiency in stretch blow molded bottles.

Although the invention has been described in considerable detail, this detail is for the purpose of illustration and is not to be construed as a limitation on the scope of the invention as described in the pending claims. When a numerical range is given, values include the end points of the range. All U.S. patents and published patent applications identified above are incorporated herein by reference.

1. A rubber modified monovinylidene aromatic polymer composition in the form of a stretch blow molded article, the composition comprising:
(A) a monovinylidene aromatic polymer a having a weight average molecular weight (Mw) of from about 190,000 to about 350,000 g/mol;
(B) from about 3.5 to about 10 percent by weight based on the weight of components (A), (B) and (C) of a grafted, cross-linked rubber polymer;
(C) optionally up to about 5 percent by weight based on the weight of components (A), (B) and (C) of a plasticizer; and
(D) optional non-polymeric additives and stabilizers.

2. A composition according to claim 1 wherein the plasticizer is selected from the group of: one or more mineral oil, one or more non-mineral oil, and blends of one or more mineral oil with one or more non-mineral oil.

3. A composition according to claim 1 wherein the Mw of the monovinylidene aromatic polymer is from at least about 215,000 to less than or equal to about 260,000 g/mol.

4. A composition according to claim 1 wherein the monovinylidene aromatic polymer is polystyrene that has been mass, bulk or solution polymerized in the presence of at least one rubber polymer.

5. A composition according to claim 1 wherein the rubber polymer is selected from the group consisting of 1,3-butadiene homopolymer rubbers, copolymers rubbers of 1,3-butadiene with one or more copolymerizable monomer and mixtures of two or more of these.

6. A composition according to claim 1 consisting essentially of:
(A) monovinylidene aromatic polymer a having a weight average molecular weight (Mw) of from about 220,000 to about 260,000 g/mol;
(B) from about 4 to about 6 percent by weight based on the weight of components (A), (B) and (C) of a rubber polymer in the form of grafted, cross-linked particles having a volume average rubber particle size of from about 2 to about 5 microns;
(C) from about 3 to about 4 percent by weight based on the weight of components (A), (B) and (C) of a plasticizer; and
(D) optional non-polymeric additives and stabilizers.

7. A rubber modified monovinylidene aromatic polymer composition according to claim 1 wherein the stretch blow molded article is a container stretch blow molded from an injection molded preform.

8. A rubber modified monovinylidene aromatic polymer composition according to claim 1 wherein the stretch blow molded article is a container stretch blow molded from a compression molded preform.

9. A rubber modified monovinylidene aromatic polymer composition according to claim 1 wherein the stretch blow molded article is a thermoformed article.

10. A rubber modified monovinylidene aromatic polymer composition comprising:
(A) a monovinylidene aromatic copolymer a having a weight average molecular weight (Mw) of from about 215,000 to about 350,000 g/mol;
(B) from about 3.5 to about 40 percent by weight based on the weight of components (A), (B) and (C) of a rubber polymer in the form of grafted, cross-linked particles having a volume average rubber particle size of from about 1.5 to about 10 microns;
(C) optionally up to about 5 percent by weight based on the weight of components (A), (B) and (C) of a plasticizer; and
(D) optional non-polymeric additives and stabilizers.

11. A rubber modified monovinylidene aromatic polymer composition according to claim 10 wherein the composition has an elongation at rupture value of from about 25 to about 70%.

12. A rubber modified monovinylidene aromatic polymer composition according to claim 10 wherein the monovinylidene aromatic polymer has a weight average molecular weight (Mw) of from about 220,000 to about 350,000 g/mol.

13. A rubber modified monovinylidene aromatic polymer composition according to claim 10 comprising from about 1.5 to about 5 percent by weight based on the weight of components (A), (B) and (C) of a plasticizer.

14. A rubber modified monovinylidene aromatic polymer composition according to claim 10 comprising from about 3.5 to about 10 percent by weight rubber polymer.

15. A composition according to claim 12 wherein the Mw of the monovinylidene aromatic polymer is from about 240,000 to about 300,000 g/mol.

16. A composition according to claim 10 wherein the monovinylidene aromatic copolymer is polystyrene-acrylonitrile) that has been mass, bulk or solution polymerized in the presence of at least one rubber polymer.

17. A composition according to claim 10 wherein the rubber polymer is selected from the group consisting of 1,3-butadiene homopolymer rubbers, copolymers rubbers of 1,3-butadiene with one or more copolymerizable monomer and mixtures of two or more of these.

18. (canceled)

19. A process for preparing a stretch blow molded article comprising the steps of
A. molding a preform from a monovinylidene aromatic polymer resin according to claim 10;
B. heating the preform;
C. stretching the preform in a stretch blow molding apparatus;
D. blowing the preform to the stretch blow molded article shape; and
E. cooling and ejection of the stretch blow molded article from the stretch blow molding apparatus.

20. The process for preparing a stretch blow molded article according to claim 19 wherein the preform is injection molded.

21. The process for preparing a stretch blow molded article according to claim 19 wherein the preform is compression molded.
